(19) United States
(12) Patent Application Publication
(10) Pub. No.: US 2026/0352560 A1
(43) Pub. Date: Nov. 5, 2026

(54) METHODS AND APPARATUS FOR HANDLING AI/ML DATA

(71) Applicant: Samsung Electronics Co., Ltd., Suwon-si, Gyeonggi-do (KR)

(72) Inventors: Chadi KHIRALLAH, Staines (GB); Milos TESANOVIC, Staines (GB); Donggun KIM, Suwon-si (KR)

(21) Appl. No.: 19/120,557

(22) PCT Filed: Oct. 11, 2023
(86) PCT No.: PCT/KR2023/015637

§ 371 Date: Apr. 11, 2025

(30) Foreign Application Priority Data
Oct. 12, 2022 (GB) 2215059.3
Sep. 18, 2023 (GB) 2314266.4

(51) Int. Cl. H04L 41/16; H04W 24/02; H04W 28/02; H04W 76/15

(52) U.S. Cl. CPC H04L 41/16; H04W 24/02; H04W 28/0268; H04W 76/15

(57) ABSTRACT

The disclosure relates to a 5G or 6G communication system for supporting a higher data transmission rate. According to an example of the present disclosure, there is provided a first entity in a communications network, the first entity comprising: a transmitter; a receiver; and at least one processor configured to: while a first connection with a user equipment (UE) is established, transmit information relating to an artificial intelligence/machine learning (AI/ML) model to a second entity in the communications network, wherein the information is usable for obtaining the AI/ML model and/or data relating to the AI/ML model; transmit, to the UE, a first message to trigger the UE to establish a second connection with the second entity, wherein the first message indicates that the second entity has obtained the AI/ML model and/or the data relating to the AI/ML model; and forward AI/ML data for the AI/ML model to the second entity.

### TECHNICAL FIELD

Certain examples of the present disclosure relate to methods, apparatus and/or systems for handling artificial intelligence/machine learning (AI/ML) data, and in particular handling AI/ML training data. Further, certain examples of the present disclosure relate to methods and apparatus for distinguishing traffic relating to training data and other data. In particular, certain examples relate to classifying traffic relating to training data. Further, certain examples of the present disclosure relate to methods and apparatus for transferring AI/ML model and/or training data between network entities (or network functions). Further, certain examples of the present disclosure relate to the notification and behaviour of network entities (or network functions) based on training status of an AI/ML model.

### BACKGROUND ART

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

The content of the following documents is referred to below and/or their content provides background information that the following disclosure should be considered in the context of:
[1]3GPP TS 22.261—Service requirements for the 5G system, SA1, Release 18 (e.g., V18.7.0);
[2] RP-213599—Study on Artificial Intelligence (AI)/Machine Learning (ML) for NR Air Interface; 3GPP TSG RAN Meeting #94e, Electronic Meeting, Dec. 6-17, 2021;
[3] 3GPP TR 37.817—Technical Specification Group Radio Access Network; Evolved Universal Terrestrial Radio Access (E-UTRA) and NR; Study on enhancement for Data Collection for NR and EN-DC; Release 17 (e.g., V17.0.0);
[4] 3GPP TS 23.501—System architecture for the 5G System (5GS); Release 17 (e.g., V17.6.0);
[5] 3GPP TS 37.340—Technical Specification Group Radio Access Network; Evolved Universal Terrestrial Radio Access (E-UTRA) and NR; Multi-connectivity; Stage 2, Release 17 (e.g., V17.2.0);
[6] 3GPP TS 38.423, Technical Specification Group Radio Access Network; NGRAN; Xn application protocol (XnAP); Release 17 (e.g., V17.2.0);
[7] RP-220635—Revised WID: Artificial Intelligence (AI)/Machine Learning (ML) for NG-RAN; 3GPP TSG RAN Meeting #95e, Electronic Meeting, Mar. 17-23, 2022.

Wireless or mobile (cellular) communications networks in which a mobile terminal (UE, such as a mobile handset) communicates via a radio link with a network of base stations, or other wireless access points or nodes, have undergone rapid development through a number of generations. The 3^{rd} Generation Partnership Project (3GPP) design, specify and standardise technologies for mobile wireless communication networks. Fourth Generation (4G) and Fifth Generation (5G) systems are now widely deployed.

3GPP standards for 4G systems include an Evolved Packet Core (EPC) and an Enhanced-UTRAN (E-UTRAN: an Enhanced Universal Terrestrial Radio Access Network). The E-UTRAN uses Long Term Evolution (LTE) radio technology. LTE is commonly used to refer to the whole system including both the EPC and the E-UTRAN, and LTE is used in this sense in the remainder of this document. LTE should also be taken to include LTE enhancements such as LTE Advanced and LTE Pro, which offer enhanced data rates compared to LTE.

In 5G systems a new air interface has been developed, which may be referred to as 5G New Radio (5G NR) or simply NR. NR is designed to support the wide variety of services and use case scenarios envisaged for 5G networks, though builds upon established LTE technologies. New frameworks and architectures are also being developed as part of 5G networks in order to increase the range of functionality and use cases available through 5G networks. One such new framework is the use of artificial intelligence/machine learning (AI/ML), which may be used for the optimisation of the operation of 5G networks.

In AI/ML operation, AI/ML models and/or data might be transferred across the AI/ML applications (e.g., application functions (AFs)), 5GC (5G core), UEs (user equipments) etc.). Without limitation, the AI/ML works could be divided into two main phases: model training and inference. During model training and inference, multiple rounds of interaction may be required.

An AI/ML model training process is generally computationally complex and may significantly impact power consumption, resources and performance of the model training network entity (that is, a network entity performing the model training; in a non-limiting example, this may be a UE). Additionally, this considerable volume of training data needs to be exchanged between application residing in the UE and its counterpart within or outside the operator's network, and needs to be send via radio links, e.g. between the UE and NG-RAN (next generation RAN (radio access network)).

In Section 6.40 AI/ML model transfer in 5GS TS 22.261 [1], three types of AI/ML operations to be supported in Release 18 are described as follows:

### a) AI/ML Operation Splitting Between AI/ML Endpoints

The AI/ML operation/model is split into multiple parts according to the current task and environment. The intention is to offload the computation-intensive, energy-intensive parts to network endpoints, whereas leave the privacy-sensitive and delay-sensitive parts at the end device. The device executes the operation/model up to a specific part/layer and then sends the intermediate data to the network endpoint. The network endpoint executes the remaining parts/layers and feeds the inference results back to the device.

### b) AI/ML Model/Data Distribution and Sharing Over 5G System

Multi-functional mobile terminals might need to switch the AI/ML model in response to task and environment variations. The condition of adaptive model selection is that the models to be selected are available for the mobile device. However, given the fact that the AI/ML models are becoming increasingly diverse, and with the limited storage resource in a UE, it can be determined to not pre-load all candidate AI/ML models on-board. Online model distribution (i.e. new model downloading) is needed, in which an AI/ML model can be distributed from a NW (network) endpoint to the devices when they need it to adapt to the changed AI/ML tasks and environments. For this purpose, the model performance at the UE needs to be monitored constantly.

### c) Distributed/Federated Learning Over 5G System

The cloud server trains a global model by aggregating local models partially-trained by each end devices. Within each training iteration, a UE performs the training based on the model downloaded from the AI server using the local training data. Then the UE reports the interim training results to the cloud server via 5G UL channels. The server aggregates the interim training results from the UEs and updates the global model. The updated global model is then distributed back to the UEs and the UEs can perform the training for the next iteration.

### DISCLOSURE OF INVENTION

### Technical Problem

The present disclosure relates to wireless communication systems and, more specifically, the invention relates to method and apparatus for handling AI/ML data Solution to Problem

It is an aim of certain examples of the present disclosure to address, solve and/or mitigate, at least partly, at least one of the problems and/or disadvantages associated with the related art, for example at least one of the problems and/or disadvantages described herein. It is an aim of certain examples of the present disclosure to provide at least one advantage over the related art, for example at least one of the advantages described herein.

According to an example of the present disclosure, there is provided a first entity in a communications network, the first entity comprising: a transmitter; a receiver; and at least one processor configured to: while a first connection with a user equipment (UE) is established, transmit information relating to an artificial intelligence/machine learning (AI/ML) model to a second entity in the communications network, wherein the information is usable for obtaining the AI/ML model and/or data relating to the AI/ML model; transmit, to the UE, a first message to trigger the UE to establish a second connection with the second entity, wherein the first message indicates that the second entity has obtained the AI/ML model and/or the data relating to the AI/ML model; and forward AI/ML data for the AI/ML model to the second entity.

According to various examples, the information relating to the AI/ML model comprises: the AI/ML model, an update to the AI/ML model, the data relating to the AI/ML model, assistance information usable for obtaining the AI/ML model and/or the data relating to the AI/ML model, or assistance information for replacing or updating previously transmitted information relating to the AI/ML model.

According to various examples, the assistance information comprises one or more of: AI/ML model ID; AI/ML model deployment; AI/ML model training; AI/ML model training status; AI/ML model transfer; AI/ML model update; AI/ML model use case;
network-UE collaboration level; training type; training session ID; training update; a training version number; training validity; or AI/ML model inference

According to various examples, one or more of: the AI/ML model deployment indicates one of the UE, the first entity, the second entity, or a combination of the first entity and the second entity; the AI/ML model training indicates one of the UE, the first entity, the second entity, or a combination of the first entity and the second entity; the AI/ML model training status indicates one or completed, untrained or partially trained; the AI/ML model transfer indicates one of full or partial; the AI/ML model update indicates one of the first entity, the second entity, a combination of the first entity and the second entity, a core network (CN) or operations, administration and maintenance (OAM); the AI/ML model use case indicates one of load balancing, energy saving, mobility optimisation, CSI feedback enhancement, beam management, and positioning accuracy enhancements; the network-collaboration UE level indicates one of the UE, the first entity, the second entity, or a collaboration between two or more of the UE, the first entity and the second entity; the training type indicates offline or online; the training update indicates one of the UE, the first entity, the second entity, or a CN; the training validity indicates a period and/or a location; or the AI/ML model inference indicates one of the UE, the first entity, the second entity, a combination of two or more of the UE, the first entity and the second entity, or another entity.

According to various examples, the at least one processor is configured to: receive data from a user plane function (UPF); and identify at least part of the data received from the UPF as the AI/ML data.

According to various examples, the at least one processor is configured to identify and/or classify the at least part of the received data as the AI/ML data based on one or more of: a label assigned to the at least part of the received data by another entity, the other entity having split the data into the AI/ML data and other data; a 5G Quality of Service (QoS) Indicator (5QI) for the AI/ML data; one or more QoS parameters of the at least part of the received data; an ID assigned to packets in the at least part of the received data; a volume, data structure and/or data format of the at least part of the received data; assistant information related to the AI/ML data received from a third entity; a QoS flow(s) or protocol data unit (PDU) session(s) used for the at least part of the received data; or stored information on one or more of frequency, size or time or frequency pattern of the AI/ML data.

According to various examples, a remaining part of the received data includes user data; and the AI/ML data is distinct from the user data.

According to various examples, one or more of: the 5QI for the AI/ML data is different to a 5QI for the user data; the one or more QoS parameters for the at least part of the received data are different to corresponding one or more QoS parameters for the remaining part of the received data; the ID comprises a training session ID and/or an ID for the AI/ML model; the QoS flow(s) or PDU session(s) used for the at least part of the received data is different to a QoS flow(s) or PDU session(s) used for the remaining part of the received data; or the stored information is obtained based on observing previous data comprising previous AI/ML data and previous user data as received by the first entity.

According to various examples, the at least one processor is configured to: split traffic, received from core network (CN), into the AI/ML data and other data; and/or wherein the AI/ML data includes training data.

According to various examples, the first message is a first radio resource control (RRC) message; and the at least one processor is configured to: receive, from the UE, a second RRC message; and facilitate establishment of the second connection.

According to various examples, the first message is a RRC reconfiguration message and the second message is an RRC reconfiguration complete message.

According to various examples, the at least one processor is configured to: receive, from the second entity, a second message indicating the second entity has obtained the AI/ML model, the data relating to the AI/ML model and/or the information relating to the AI/ML model; and/or transmit, to the second entity, the information relating to the AI/ML model in response to a request for transfer of the AI/ML model and/or the data relating to the AI/ML model received from the second entity.

According to various examples, the at least one processor is configured to: perform training of the AI/ML model based on other AI/ML data for the AI/ML model and/or data stored in the first entity; and/or receive, from the second entity, an updated AI/ML model and/or other data relating to the AI/ML model.

According to various examples, the first entity is configured to jointly perform training of the AI/ML model with the second entity; and/or the first entity is configured to: perform model inference or jointly perform model interference with the second entity based on the AI/ML model or an updated AI/ML model, wherein the updated AI/ML model results from performing the training of the AI/ML model.

According to various examples, the at least one processor is configured to: receive, from the second entity, a model training status based on training of the AI/ML model, or a notification of completion of the training; and/or upon completion of the training, cause release of the second entity to be triggered.

According to various examples, a dedicated channel is used for forwarding the AI/ML to the second entity; and the dedicated channel allows the AI/ML data to be processed differently to other data.

According to various examples, the at least one processor is configured to: forward further AI/ML data for the AI/ML model to the second entity; and receive, from the second entity, a reject message indicating a cause of failure.

According to another example of the present disclosure, there is provided a second entity in a communications network, the second entity comprising: a transmitter; a receiver; and at least one processor configured to: receive, from a first entity in the communications network and having a first connection with a user equipment (UE), information relating to an artificial intelligence/machine learning (AI/ML) model, wherein the information is usable for obtaining the AI/ML model and/or data relating to the AI/ML model; obtain the AI/ML model and/or the data relating to the AI/ML model, based on the information; establish a second connection with the UE; receive, from the first entity, AI/ML data for the AI/ML model; and perform, based on the obtained AI/ML model and/or the data relating to the AI/ML model, training of the AI/ML model to provide an updated AI/ML model based on the second connection.

According to various examples, the information relating to the AI/ML model comprises: the AI/ML model, an update to the AI/ML model, the data relating to the AI/ML model, assistance information usable for obtaining the AI/ML model and/or the data relating to the AI/ML model, or assistance information for replacing or updating previously received information relating to the AI/ML model.

According to various examples, the assistance information comprises one or more of: AI/ML model ID; AI/ML model deployment; AI/ML model training; AI/ML model training status; AI/ML model transfer; AI/ML model update; AI/ML model use case; network-UE collaboration level; training type; training session ID; training update; a training version number; training validity; or AI/ML model inference.

According to various examples, one or more of: the AI/ML model deployment indicates one of the UE, the first entity, the second entity, or a combination of the first entity and the second entity; the AI/ML model training indicates one of the UE, the first entity, the second entity, or a combination of the first entity and the second entity; the AI/ML model training status indicates one or completed, untrained or partially trained; the AI/ML model transfer indicates one of full or partial; the AI/ML model update indicates one of the first entity, the second entity, a combination of the first entity and the second entity, a core network (CN) or operations, administration and maintenance (OAM); the AI/ML model use case indicates one of load balancing, energy saving, mobility optimisation, CSI feedback enhancement, beam management, and positioning accuracy enhancements; the network-collaboration UE level indicates one of the UE, the first entity, the second entity, or a collaboration between two or more of the UE, the first entity and the second entity; the training type indicates offline or online; the training update indicates one of the UE, the first entity, the second entity, or a CN; the training validity indicates a period and/or a location; or the AI/ML model inference indicates one of the UE, the first entity, the second entity, a combination of two or more of the UE, the first entity and the second entity, or another entity.

According to various examples, the at least one processor is configured to transmit the AI/ML data to the UE for model training, and/or perform the training using the AI/ML data; and/or wherein the AI/ML data includes training data.

According to various examples, a first dedicated channel is used for transmitting the AI/ML data to the UE and/or a second dedicated channel is used for receiving the AI/ML data from the first entity; and the first dedicated channel and the second dedicated channel allow the AI/ML data to be processed differently to other data.

According to various examples, the at least one processor is configured to: transmit the AI/ML data using one or more of: best effort, non-guaranteed bit rate (non-GBR), or low QoS values data radio bearers (DRB); a modulation and coding scheme, a security and protection level, an energy requirement, a reliability requirement, a bandwidth part (BWP), a carrier, or a carrier group, that differs compared to that used for other data (e.g. the other data may be user data or non-AI/ML data).

According to various examples, the AI/ML data is transmitted or processed with a different priority than that of the other data.

According to various examples, the at least one processor is configured to transmit, to the first entity, a message indicating the second entity has obtained the AI/ML model, the data relating to the AI/ML model and/or the information relating to the AI/ML model; the at least one processor is configured to transmit, to the first entity, a model training status based on the training of the AI/ML model, or a notification of completion of the training of the AI/ML model; and/or upon completion of the training, release of the second entity is triggered.

According to various examples, the at least one processor is configured to: transmit, to the first entity, a request for transfer of the AI/ML model and/or the data relating to the AI/ML model; and receive, from the first entity, the information relating to the AI/ML model in response to the request.

According to various examples, the at least one processor is configured to: receive further AI/ML data for the AI/ML model from the first entity; determine that the further AI/ML data is not supported; and transmit, to the first entity, a reject message indicating a cause of failure.

According to various examples, the first entity is a first next generation radio access network (NG-RAN), a master NG-RAN (M-NG-RAN) node, a first secondary NGRAN (S-NG-RAN) node, or a first next generation Node B (gNB); the second entity is a second NG-RAN, a second S-NG-RAN node, or a second gNB; and/or the communications network is a 5G network.

According to another example of the present disclosure, there is provided a method in a communications network comprising a first entity and a second entity, the method comprising: while a first connection with a user equipment (UE) is established, transmitting, by the first entity, information relating to an artificial intelligence/machine learning (AI/ML) model to a second entity, wherein the information is usable for obtaining the AI/ML model and/or data relating to the AI/ML model; obtaining, by the second entity, the AI/ML model and/or the data relating to the AI/ML model, based on the received information relating to the AI/ML model; transmitting, by the first entity to the UE, a first message to trigger the UE to establish a second connection with the second entity, wherein the first message indicates that the second entity has obtained the AI/ML model and/or the data relating to the AI/ML model; establishing, by the second entity, a second connection with the UE; forwarding, by the first entity, AI/ML data for the AI/ML model to the second entity; and performing, based on the obtained AI/ML model and/or the data relating to the AI/ML model, training of the AI/ML model to provide an updated AI/ML model based on the second connection.

According to another example of the present disclosure, there is provided a method of a first entity in a communications network, the method comprising: while a first connection with a user equipment (UE) is established, transmitting information relating to an artificial intelligence/machine learning (AI/ML) model to a second entity in the communications network, wherein the information is usable for obtaining the AI/ML model and/or data relating to the AI/ML model; transmitting, to the UE, a first message to trigger the UE to establish a second connection with the second entity, wherein the first message indicates that the second entity has obtained the AI/ML model and/or the data relating to the AI/ML model; and forwarding AI/ML data for the AI/ML model to the second entity.

According to another example of the present disclosure, there is provided a method of a second entity in a communications network, the method comprising: receiving, from a first entity in the communications network and having a first connection with a user equipment (UE), information relating to an artificial intelligence/machine learning (AI/ML) model, wherein the information is usable for obtaining the AI/ML model and/or data relating to the AI/ML model; obtaining the AI/ML model and/or the data relating to the AI/ML model, based on the information; establishing a second connection with the UE; receiving, from the first entity, AI/ML data for the AI/ML model; and performing, based on the obtained AI/ML model and/or the data relating to the AI/ML model, training of the AI/ML model to provide an updated AI/ML model based on the second connection.

According to various examples, there are provided methods of the first entity and methods of the second entity, said methods including operations and/or features corresponding to the operations and/or features of the respective one of the first entity and the second entity which are described in any of the various examples disclosed above.

According to another example of the present disclosure, there is provided a computer program comprising instructions which, when the program is executed by a computer, cause the computer to carry out a method according to any of the examples described above.

According to another example of the present disclosure, there is provided a network comprising a first entity according to any of the examples described above and a second entity according to any of the examples described above.

Other aspects, advantages, and salient features of the invention will become apparent to those skilled in the art from the following detailed description taken in conjunction with the accompanying drawings.

### Advantageous Effects of Invention

Advantages, and salient features of the invention will become apparent to those skilled in the art from the following detailed description, which, taken in conjunction with the annexed drawings, discloses exemplary embodiments of the invention.

According to various embodiments of the present disclosure, method and apparatus for handling AI/ML data.

### BRIEF DESCRIPTION OF DRAWINGS

Embodiments of the present disclosure are further described hereinafter with reference to the accompanying drawings, in which:

FIG. 1 shows a representation of a method or call flow according to an example of the present disclosure.

FIG. 2 shows a representation of a method or call flow according to another example of the present disclosure.

FIG. 3 shows a representation of a method or call flow according to another example of the present disclosure.

FIG. 4 shows a representation of a method or call flow according to another example of the present disclosure.

FIG. 5 shows a representation of a method or call flow according to another example of the present disclosure.

FIG. 6 is a block illustrating an example structure of a network entity or network function in accordance with certain examples of the present disclosure.

### MODE FOR THE INVENTION

The following description of examples of the present disclosure, with reference to the accompanying drawings, is provided to assist in a comprehensive understanding of certain examples of the present invention. The description includes various specific details to assist in that understanding but these are to be regarded as merely exemplary. Accordingly, those of ordinary skill in the art will recognize that various changes and modifications of the examples described herein can be made without departing from the scope of the invention or disclosure.

The same or similar components may be designated by the same or similar reference numerals, although they may be illustrated in different drawings.

Detailed descriptions of techniques, structures, constructions, functions or processes known in the art may be omitted for clarity and conciseness, and to avoid obscuring the subject matter of the present disclosure.

The terms and words used herein are not limited to the bibliographical or standard meanings, but are merely used to enable a clear and consistent understanding of the invention.

Throughout the description of this specification, the words “comprise”, “include” and “contain” and variations of the words, for example “comprising” and “comprises”, means “including but not limited to”, and is not intended to (and does not) exclude other features, elements, components, integers, steps, processes, operations, functions, characteristics, properties and/or groups thereof.

Throughout the description of this specification, the singular form, for example “a”, “an” and “the”, encompasses the plural unless the context otherwise requires. For example, reference to “an object” includes reference to one or more of such objects.

Throughout the description, the expression “at least one of A, B and/or C” (or the like) and the expression “one or more of A, B and/or C” (or the like) should be seen to separately include all possible combinations, for example: A, B, C, A and B, A and C, A and B and C.

Throughout the description of this specification, language in the general form of “X for Y” (where Y is some action, process, operation, function, activity or step and X is some means for carrying out that action, process, operation, function, activity or step) encompasses means X adapted, configured or arranged specifically, but not necessarily exclusively, to do Y.

Features, elements, components, integers, steps, processes, operations, functions, characteristics, properties and/or groups thereof described or disclosed in conjunction with a particular aspect, embodiment, or example are to be understood to be applicable to any other aspect, embodiment, or example described herein unless incompatible therewith.

Certain examples of the present disclosure provide methods, apparatus and/or systems for: differentiating traffic (or data packet(s)) associated with AI/ML training data; classifying traffic (or data packet(s)) as being associated with AI/ML training data; providing an indication that traffic (or data packet(s)) are associated with AI/ML training data; transferring or transmitting an AI/ML model and/or assistance information associated with training for an AI/ML model between network entities/functions; controlling notification and/or behaviour of a network entity/function based on traffic (or data packet(s)) being associated with AI/ML training data; and controlling notification and/or behaviour of a network entity/function based on training status of a AI/ML model. Note, however, that the present disclosure is not limited to these examples, and includes other examples.

The following examples are applicable to, and use terminology associated with, 3GPP 5G. However, the skilled person will appreciate that the techniques disclosed herein are not limited to these examples or to 3GPP 5G, and may be applied in any suitable system or standard, for example one or more existing and/or future generation wireless communication systems or standards. The skilled person will appreciate that the techniques disclosed herein may be applied in any existing or future releases of 3GPP 5G NR or any other relevant standard. For example, the functionality of the various network entities and other features disclosed herein may be applied to corresponding or equivalent entities or features in other communication systems or standards. Corresponding or equivalent entities or features may be regarded as entities or features that perform the same or similar role, function, operation or purpose within the network.

A particular network entity may be implemented as a network element on a dedicated hardware, as a software instance running on a dedicated hardware, and/or as a virtualised function instantiated on an appropriate platform, e.g. on a cloud infrastructure.

The skilled person will appreciate that the present invention is not limited to the specific examples disclosed herein. For example:
The techniques disclosed herein are not limited to 3GPP 5G.
One or more entities in the examples disclosed herein may be replaced with one or more alternative entities performing equivalent or corresponding functions, processes or operations.
One or more of the messages in the examples disclosed herein may be replaced with one or more alternative messages, signals or other type of information carriers that communicate equivalent or corresponding information.
One or more further elements, entities and/or messages may be added to the examples disclosed herein.
One or more non-essential elements, entities and/or messages may be omitted in certain examples.
The functions, processes or operations of a particular entity in one example may be divided between two or more separate entities in an alternative example.
The functions, processes or operations of two or more separate entities in one example may be performed by a single entity in an alternative example.
Information carried by a particular message in one example may be carried by two or more separate messages in an alternative example.
Information carried by two or more separate messages in one example may be carried by a single message in an alternative example.
The order in which operations are performed may be modified, if possible, in alternative examples.
The transmission of information between network entities is not limited to the specific form, type and/or order of messages described in relation to the examples disclosed herein.

Certain examples of the present disclosure may be provided in the form of an apparatus/device/network entity configured to perform one or more defined network functions and/or a method therefor. Such an apparatus/device/network entity may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). Certain examples of the present disclosure may be provided in the form of a system (e.g., a network) comprising one or more such apparatuses/devices/network entities, and/or a method therefor.

It will be appreciated that examples of the present disclosure may be realized in the form of hardware, software or a combination of hardware and software. Certain examples of the present disclosure may provide a computer program comprising instructions or code which, when executed, implement a method, system and/or apparatus in accordance with any aspect, example and/or embodiment disclosed herein. Certain embodiments of the present disclosure provide a machine-readable storage storing such a program.

In RP-213599 [2], 3GPP agreed a new Release 18 “Study on Artificial Intelligence (AI)/Machine Learning (ML) for NR Air Interface”. The initial set of use cases under study in 3GPP Technical Specification Group (TSG) RAN1 (RAN Working Group 1 (WG1)) includes: CSI feedback enhancement, Beam management, and positioning accuracy enhancements. 3GPP TSG RAN2 (RAN Working Group 2 (WG2)) is also involved in this study and will be addressing the following protocol aspects:
Consider aspects related to, e.g., capability indication, configuration and control procedures (training/inference), and management of data and AI/ML model, per RAN1 input.
Collaboration level specific specification impact per use case

In 3GPP RAN1 #109-e meeting, RAN1 agreed the following different levels of collaboration between the network and UE:

Agreement

Take the following network-UE collaboration levels as one aspect
for defining collaboration levels
1. Level x: No collaboration
2. Level y: Signaling-based collaboration without model transfer
3. Level z: Signaling-based collaboration with model transfer

In 3GPP RAN1 #110-e meeting, RAN1 made the following working assumption on the general aspects of AI/ML framework:

Working Assumption

| Terminology | Description |
|---|---|
| Online | An AI/ML training process where the model being used |
| training | for inference) is (typically continuously) trained in |
| | (near) real-time with the arrival of new training samples. |
| Offline | An AI/ML training process where the model is trained |
| training | based on collected dataset, and where the trained |
| | model is later used or delivered for inference. |

Working Assumption

| Terminology | Description |
|---|---|
| AI/ML model | A generic term referring to delivery of an AI/ML |
| delivery | model from one entity to another entity in any |
| | manner. Note: An entity could mean a network |
| | node/function (e.g., gNB, LMF, etc.), UE, |
| | proprietary server, etc. |

In RP-220635 [7], an objective of the work item (WI) is defined as follows:

Normative work is based on the conclusions captured in TR 37.817 ([3]). The detailed objectives of the WI are listed as follows:
Specify data collection enhancements and signaling support within existing NG-RAN interfaces and architecture (including non-split architecture and split architecture) for AI/ML-based Network Energy Saving, Load Balancing and Mobility Optimization. (RAN3)
[Note: RAN3—3GPP TSG RAN Working Group 3 (WG3)]

In 3GPP RAN3 #117-e meeting, RAN3 agreed the following (points beginning ‘FFS’ are still open points):
Define a new procedure over Xn (interface) which can be used for AI/ML related information, e.g., predicted information.
FFS whether to use the existing procedure or dedicated new procedure for other input, output and feedback information.
The new procedure for reporting of AI/ML related information, e.g., predicted information, should be based in a requested way, like resource status report procedure.
The new procedure over Xn used for AI/ML related information should be non-UE associated as a start point.
FFS on whether UE associated procedure is needed.

As discussed above, an AI/ML model training process is generally computationally complex and may significantly impact power consumption, resources and performance of the model training network entity. Additionally, a considerable volume of training data may need to be exchanged between an application(s) residing in the model training network entity (e.g., a UE) and its counterpart(s) within or outside the (operator's) network, and it may need to be sent via radio links, e.g. between the UE (model training network entity) and a next generation radio access network (NG-RAN). In general, an NG-RAN would treat user data and training data similarly, i.e. in terms of radio protocol procedures, resulting in similar assigned power and computational resources.

In consideration of the above, certain examples of the present disclosure provide apparatus, system(s), network(s) and/or method(s) to distinguish training data (e.g., AI/ML training data, application training data etc.) from other data (e.g., user data, or data not associated with training of a AI/ML model). For example, classifying data may allow for the distinguishing of training data in the network. In certain examples of the present disclosure, distinguishing the training data is based on use of one or both of two new classes of 5G Quality of Service Identifiers (5QIs), e.g., a 5QI associated with AI/ML training GBR (guaranteed bit rate), and a 5QI associated with AI/ML training non-GBR.

Also, certain examples of the present disclosure provide apparatus, system(s), network(s) and/or method(s) to differentiate treatment (that is, to treat differently) such training data and the other data (e.g., user data) at a network entity (or network function) and/or UE, based in part on the classification (or distinguishing) of data. For example, a network entity/function and a UE may treat data differently depending on whether the data is identified to be AI/ML training data or user data, based on a classification method for distinguishing the training data. For example, a network entity may be a UE, a network node, or an application etc.

Also, certain examples of the present disclosure provide apparatus, system(s), network(s) and/or method(s) to enable a network entity and/or a UE to perform model training in another network entity in a dual-connectivity scenario (e.g., E-UTRAN New Radio-Dual Connectivity (EN-DC), or multi-RAT Dual Connectivity (MR-DC) etc.).

Also, certain examples of the present disclosure provide apparatus, system(s), network(s) and/or method(s) relating to notification and behaviour of network entities based on model training status. For example, a network entity may explicitly or implicitly notify/report, to another network entity, a training status of an AI/ML model, and may also optionally transmit the model to the other network entity.

A person skilled in the art would appreciate that examples described herein may apply to dual connectivity (DC) scenarios/cases and standalone (SA) scenarios/cases, with or without modification as appropriate. Additionally, a person skilled in the art would appreciate that examples described herein may apply to one or more, or all, DC scenarios/cases (e.g., EN-DC, MR-DC) and related network entities/function (e.g., ENDC, S-eNB (secondary eNB), SN (secondary node), MN (master node), S-GW (serving gateway), MME (mobility and management entity); MR-DC with 5GC (5G core), NG-eNB (next generation eNB), gNB, MN, SN, UPF (user plane function), AMF (access and mobility management function).

It should be noted that, although the present disclosure may, on occasion, refer to a network entity and a network function separately, the skilled person would understand that a network function may be an example of a network entity. Additionally, in the present disclosure, reference will be made to traffic or data packets associated with, or related to, training data (or similar); it will be appreciated that included within the scope of such traffic or data packets are cases of the traffic or data packets being training data, as well as cases where the traffic or data packets are associated with, or related to, or correspond to, training data. Furthermore, in the present disclosure, examples may refer to classifying traffic, determining whether traffic is related to training data, operating differently if the traffic relates to training data etc.; it will be appreciated that the present disclosure should be considered to equivalently include examples where the term “traffic” is replaced by “data packet(s)” (it is also noted that some examples of the present disclosure refer to both traffic and/or data packets, thereby demonstrating that the present disclosure consistently considers both cases of traffic and cases of data packet(s)).

As mentioned above, according to certain examples of the present disclosure, there is provided apparatus, system(s), network(s) and/or method(s) to distinguish training data (e.g., AI/ML training data, application training data etc.) from other data (e.g., user data). For example, a method is provided for distinguishing AI/ML training data from user data in a network.

In an example, the network classifies traffic/data packets into application training data and/or user data. In an example, the method of classification may depend on whether the training data is labelled by an application function (AF) in a way that the (mobile) network can understand that data in this class are training data.

In certain cases where the labelling and/or data format can be interpreted by the (mobile) network, the network may distinguish training data from user data based on one or more of the following methods/arrangements:
Ouality of Service (QoS) profile/parameters/characteristics are different for training data to that/those of user data. For example, referring to the example of Table 1 (see below), a network (entity/function) and/or an AF may assign for the training data:
A new 5QI class of service identifier/value (i.e. new 5QI index in the 5QI table); such as “AI/ML training Non-GBR”, “AI/ML training GBR”; or
An existing 5QI class of service identifier different to that of user data (e.g. 5QI Value 3 for Real-time training data/samples (not shown in Table 1)).
Packets are assigned a training session ID, AI/ML model ID, or other ID.
E.g. this ID may be assigned to the packet by an internal or external network entity/function and/or an AF (or an application).
The training data volume, data structure and/or data format.
Existing or newly defined methods for packet inspection.
Assistant information from an external and/or internal network entity/function and/or AF to assist the network to distinguish training data packets.

In an example, an AF may directly or via another network entity/function (e.g., for 5GC case: AMF, SMF (session management function), or other entity/function), provide to the traffic classification entity (e.g. for 5GC case: UPF, NG-RAN, or other entity) assistant information related to training data packets/streams to assist training data classification at this entity.

In another example, training data packets are differentiated from user data packets at the UPF entity, based on one or multiple criteria mentioned above and/or any other suitable traffic classification criteria.

In another example, training data packets are differentiated from the user data packets at the NG-RAN node, based on one or multiple criteria mentioned above and/or any other suitable traffic classification criteria.

In another example, training data packets/streams may be sorted into QoS flows (or PDU (protocol data unit) session(s)) that are different to the QoS flows (or PDU session(s)) that are used for user data.

In another example, training data packets/traffic/streams may be combined with the user data packets into the same QoS flows (or PDU session(s)).

According to certain examples, if the training data is labelled by an AF and/or an operating system using different IP headers (e.g., different ToS (type of service) field/DS (differentiated services) field; and/or use of ECN (explicit congestion notification) bits to indicate training data vs. user data), then the UPF can apply different QoS parameters to the training data and user data.

Further, in certain examples, if the training data is not labelled by AF and/or operating system, classification can be done as follows:
Based on knowledge of one or more of frequency, size or time or frequency pattern of training data, e.g. based on type of application and/or type of ML algorithm used including the knowledge of a specific rule applied; and/or
Based on learnt (e.g. via ML) knowledge of frequency/size/pattern of training data, by observing enough data packets and identifying training data, e.g.:
By knowing or learning user traffic properties (such as burst length, periodicity, and/or ON-OFF periods etc.) and identifying training data as data with different properties from said user traffic properties; and/or
By knowing or learning user traffic properties (such as burst length, periodicity, and/or ON-OFF periods etc.) and identifying training data as data with some similar properties to user data (e.g. part of same burst/having same periodicity) but with some different properties from said user traffic properties (e.g. different packet size).

In certain examples, the network (for example, the traffic classification entity, nonlimiting examples of which are given above) may also classify, or identify, training data based on assistance information from the CN, e.g., based on analytics and/or predictions obtained from NWDAF (Network Data Analytics Function), or other network (NW) entity/function.

According to certain examples of the present disclosure, there is provided a network entity or network function arranged to differentiate between traffic or data packets associated with training data, such as AI/ML model training data, and traffic or data packets associated with other data, such as user data. That is, a network entity/function may be configured to identify (or detect, or determine etc.) that traffic or data packets are related to training data. A network entity/function in accordance with some examples of the present disclosure may classify (or label, or denote) the traffic or data packets as being associated with training data. For example, the traffic or data packets may be labelled as being associated with training data, or information may be included with (or linked to) the traffic or data packets, where the information indicates that the traffic or data packets are associated with training data, or information indicates that the traffic or data packets are associated with training data may be sent separately. For example, the network entity may generate an indicator to inform another network entity/function that the traffic or data packets are associated with training data, and may transmit this indicator to the other network entity/function, for example at, before or after the time of forwarding the traffic or data packets to the other network entity/function. For example, training data may be one type of traffic, while use data may be another type of traffic.

Based on traffic or data packets being classified as, or determined to be, related to training data, the network entity/function or another network entity/function may perform one or more operations. Said one or more operations may differ compared to an operation(s) performed in a case where the traffic or data packets do not relate to training data. This will be discussed in more detail below.

It will be appreciated that the network entity/function which classifies the traffic or data packets as training data may receive the traffic or data packets from another network entity/function in the network, or may itself generate the traffic or data packets. In the case of the former, the network entity/function may be configured to determine that the traffic or data packets are associated with training data using one of the methods described above (e.g., based on use of a new or existing 5QI, based on at least one characteristic of the traffic or data packets etc.); and in the case of the latter, the network entity/function may classify or otherwise indicate the traffic or data packets as being related to training data, in such a way that the network (e.g., another entity/function in the network, such as the entity/function to perform the model training or requiring/requesting the training data) may identify that the traffic or data packets are related to training data.

In examples mentioned above, reference is made to new types, or classes, of 5QI values. Accordingly, certain examples of the present disclosure provide (or generate, or assign) such new types/classes of 5QI values, which may be for training data traffic (that is, traffic related to training data).

In an example, a new 5QI value, or a new type/class of 5QI value, is provided for indicating training data traffic. In another example, new 5QI values, or new types/classes of 5QI value, are provided to distinguish between different types, or classes, of training data traffic. For example, there may be provided either or both of the following types/classes of 5QI values:
1) “AI/ML training data GBR”, e.g., training samples/data used for Real-time/(near) Real-time/Online AI/ML model training service;
2) “AI/ML training data non-GBR”, e.g., training samples/data used for Offline AI/ML model training service.

As a non-limiting example, Table 1 shows the above-defined new types/classes of training data traffic in relation to 3GPP standardised 5QI, with the information relating to 5QI values 1, 5 and 82 shown in Table 5.7.4-1 of section 5.7.4 of TS 23.501 [4](it will be appreciated that Table 1 omits some information shown in Table 5.7.4-1 of section 5.7.4 of TS 23.501 [4] for brevity).

TABLE 1
Standardized 5QI to QoS characteristics mapping

| | | | | | Default | | |
|---|---|---|---|---|---|---|---|
| | | | Packet | | Maximum | | |
| | | | Delay | | Data | | |
| | | Default | Budget | Packet | Burst | Default | |
| 5QI | Resource | Priority | (NOTE | Error | Volume | Averaging | Example |
| Value | Type | Level | 3) | Rate | (NOTE 2) | Window | Services |
| 1 | GBR | 20 | 100 ms | 10⁻² | N/A | 2000 ms | Conversational |
| | | | (NOTE 11, | | | | Voice |
| | | | NOTE 13) | | | | |
| [ . . . ] | | | | | | | |
| 5 | Non-G | 10 | 100 ms | 10⁻⁶ | N/A | N/A | IMS Signalling |
| | BR | | NOTE | | | | |
| | | | 10, 3) | | | | |
| | | | NOTE 1 | | | | |
| [ . . . ] | | | | | | | |
| 82 | Delay- | 19 | 10 ms | 10⁻⁴ | 255 bytes | 2000 ms | Discrete |
| | critical | | (NOTE 4) | | | | Automation (see |
| | GBR | | | | | | TS 22.261 [2]) |
| [ . . . ] | | | | | | | |
| zz | AI/ML | 60 | 300 ms | 10−6 | N/A | N/A | Offline AI/ML |
| | training | | | | | | model training |
| | Non- | | | | | | (NOTE XX). |
| | GBR | | | | | | |
| cc | AI/ML | 30 | 50 ms | 10−3 | N/A | 2000 ms | (near) Real Time |
| | training | | | | | | /Online AI/ML |
| | GBR | | | | | | model training |
| | | | | | | | (NOTE XY). |

[ . . . ]
(NOTE XX) This service is for AI/ML training where the model is trained in non-real-time with collected datasets of training data.
(NOTE XY) This service is for AI/ML training where the model is trained in (near) real-time with arrival of training data (in real-time).

The above newly-introduced traffic classes and related QoS parameters are used only as one example; in other examples, other QoS parameters values may also apply to the newly defined classes, in addition to or instead of one or more of the QoS parameters shown in Table 1. It will be appreciated that, in certain examples, the newly-introduced traffic classes relate to one or more of the QoS parameters shown in Table 1, as opposed to all of those shown in Table 1.

According to certain examples of the present disclosure, as an alternative to introducing a new 5QI value for (indicating) the training data, the network (e.g., network entity, or network function) or the AF may assign one or more existing 5QI values (for example, one or more of the 3GPP standardised 5QI values as shown in Table 5.7.4-1 of section 5.7.4 of TS 23.501 [4]) for the training data traffic or data packets. For instance, the assigned existing value may be different to one which may be assigned for user data.

Accordingly, certain examples of the present disclosure include a network entity/function which is configured to apply a (new or appropriately-selected existing) 5QI value, or generate an indication of such a 5QI value, for traffic or data packets which is determined to be associated with or related to training data. For example, the indication of the 5QI value may be sent to another network entity/function to allow the other network entity/function to determine that the traffic or data packets (sent or to be sent to the other network entity/function) are related to training data for AI/ML model (e.g., thereby allowing the other network entity/function to react to the traffic or data packets in a different manner to if the traffic or data packets were associated with user data). For example, through being labelled or tagged with the 5QI value to indicate the traffic or data packets are related to training data, a network entity may determine to process the traffic or data packets differently, such that transmission properties/parameters specified for training data (or data associated with training data) are used for the traffic (or data packets).

In certain examples of the present disclosure, the user data includes (or is) one or more of: user-generated data, application generated data, non-overhead data, data originating from outside the network and/or application (such as user-generated, or generated by another application) etc.

Above are described methods, and apparatus, for classifying traffic or data packets into training data and/or user data, and also methods, and apparatus, for distinguishing training data (e.g., distinguishing training data traffic from user data traffic). Accordingly, certain examples of the present disclosure relate to one or more operations of the network based on the classification, distinction or identification of the traffic (e.g., based on identifying traffic to be training data traffic, and/or identifying (other) traffic to be user data).

According to an example of the present disclosure, the network may be configured to split (or divide, or apportion) the traffic or data packets, e.g., into training data or user data, at different entities or functions in the network (for example: 5GC, NG-RAN, other). For example, this splitting may be based on classifying traffic into training data and user data; that is, the network identifies that traffic is associated with training data and other traffic is associated with user data, based on the training data being distinguished.

In an example, a UPF may split a PDU session during PDU Session Resource Setup, in order to enable separation of training data traffic from user data traffic. Optionally, the UPF sends the training data to desired NG-RAN data using user plane (e.g. UPF sends training data to SN for model training at the SN).

In another example, a UPF may split a PDU session during PDU Session Resource Modify in order to enable separation of data traffic from the user data traffic. Optionally, the UPF sends the training data to desired NG-RAN data using user plane (e.g. UPF sends training data to SN for model training at the SN).

In another example, a NG-RAN may split a PDU session and forward training traffic (e.g. QoS flows carrying training data) to another NG-RAN for model training at this other NG-RAN.

In another example, a MN (e.g., M-NG-RAN (master next generation radio access network) node) may perform SN (S-NG-RAN (secondary next generation radio access network) node) Addition procedure, split a PDU session, and forward training data, received from the network (e.g. UPF via UP), to the newly added SN that performs model training.

In another example, a MN (M-NG-RAN node) may perform SN (S-NG-RAN node) Addition procedure, optionally including assistant information on the desired AI/ML model(s) to a SN, split a PDU session, and forward training data, received from the network (e.g. UPF via UP), to the newly added SN that performs model training.

In another example, a MN (M-NG-RAN node) may perform SN (S-NG-RAN node) Modification Request procedure, optionally including assistant information on the desired AI/ML model(s) to a SN, split a PDU session, and forward training data, received from the network (e.g. UPF via UP), to the newly added SN that performs model training.

In another example, a MN (M-NG-RAN node) may send the received training data to a SN (S-NG-RAN node), for example, using the F1-C Traffic Transfer message.

According to certain examples of the present disclosure, a network entity (or network function) that received training data (e.g., from the core network) may perform the training (e.g., the AI/ML model training) and/or forward the training data to another network entity or network function (e.g., a UE) in order for the other entity/function to perform the model training. For example, a UE may receive the training data from another network entity or a network function and, assuming the UE has already downloaded or received the AI/ML model, the UE may perform the model training.

In order to reduce energy consumption and/or resources needed to perform the complex model training procedure, the network (e.g., a network entity/function included in the network) may, optionally, before performing model training locally or forwarding the training data to the other network entity/function, process the training data. For example, the processing may include or result in one or more of the following operations/methods/arrangements:
Training data may be offered one or more of: different modulation and coding schemes, different security and protection level, lower delay, lower energy and/or lower reliability requirements (e.g. less robust transmission parameters). That is, fewer radio resources (e.g. fewer headers; fewer retransmissions; and/or fewer bits spent on channel coding etc.).
The network (e.g., a NG-RAN) or the network entity/function may send the data training packets to the other network entity/function (e.g., the UE) using best-effort/non-GBR/low QoS values DRBs (data radio bearers).
The network (e.g., a NG-RAN) or the network entity/function may use at least one of different bandwidth parts, different carriers (CA), or even carrier groups (MCG/SCG) for the training data.
The network (e.g., a NG-RAN) or the network entity/function may use the same carrier but have different LCP (logical channel prioritization) values configured, and/or different L1/L2 transmission parameters configured (e.g. channel coding, HARQ (Hybrid Automatic Repeat Request) for the training data.
The NG-RAN may combine the training data and user data in the same DRBs or separate DRBs.

In the present disclosure, there is discussion of transmitting or transferring training data and/or an AI/ML model in the network. Certain examples of the present disclosure provide methods (and corresponding apparatus, system(s) etc.) for an network entity/function, such as a NG-RAN node (e.g., MN) to transfer AI/ML model and/or related training data (e.g. received from CN, AF, OAM (Operations, Administration and Maintenance), other), to another network entity/function, such as another NG-RAN node (e.g. SN) to perform model training. In another example, a network entity/function (e.g. an NG-RAN entity such as MN) may assist another entity (e.g., a SN) in downloading or obtaining the desired AI/ML model and/or training data from another network entity/function (and/or OAM, AF, other). For example, the SN obtains the model and/or training data from the network (e.g., directly from CN or via NG-RAN, or other) using control plane (CP) signalling/interfaces/procedure/messages. It will be appreciated that the following examples may apply in any order and/or may be taken in any combination.

In an example, the network entity/function may send information (e.g., assistance information) to the other network entity/function. For example, considering “AI/ML model Assistant Information” as an example of such information:
The NG-RAN (e.g., MN or SN) sends one or more of the following assistance information (or sends assistance information comprising one or more of the following or an indication thereof) to the newly added or modified NG-RAN (e.g., SN):
a. The AI/ML model ID;
b. The AI/ML model deployment (e.g., UE-side, MN-side, SN-side, joint/split-deployment (MN-SN), or other);
c. The AI/ML model training (e.g., UE-side, MN-side, SN-side, Joint/split-training (MN-SN), or other);
d. The AI/ML model training status (e.g., completed, untrained, partially-trained, or other);
e. The AI/ML model transfer (e.g., Full, Partial, or some model parameters);
f. The AI/ML model update (e.g., MN, SN, MN-SN, CN, OAM, or other);
g. The AI/ML model use case (e.g., load balancing, Energy saving, Mobility Optimisation, CSI feedback enhancement, Beam management, and Positioning accuracy enhancements, or other);
h. The network-UE collaboration level (e.g., UE-side, MN-side, SN-side, UE-MN, UE-SN, UE-MN-SN (joint/multiple node-UE collaboration));
i. Training type (e.g., Online, Offline, or other);
j. The training session ID;
k. Training update (e.g., UE-initiated, MN-initiated, SN-initiated, CN-initiated, or other);
l. Training validity (e.g., period, or location, or other);
m. The AI/ML model inference (e.g., UE-side, SN-side, MN-side, joint inference MN-SN, UE-MN-SN, or other); and
n. Other parameters related to AI/ML model.

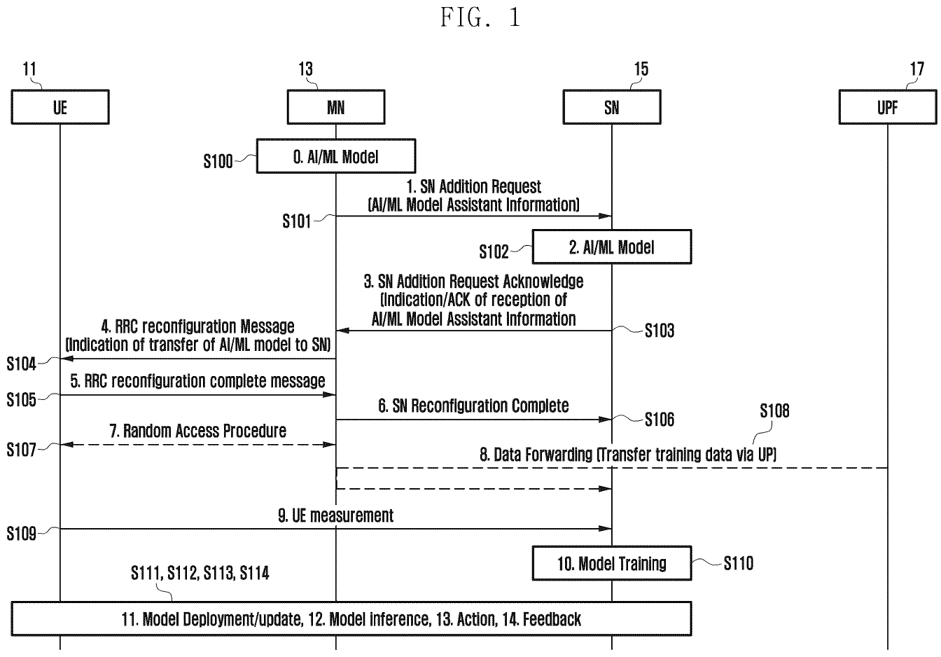

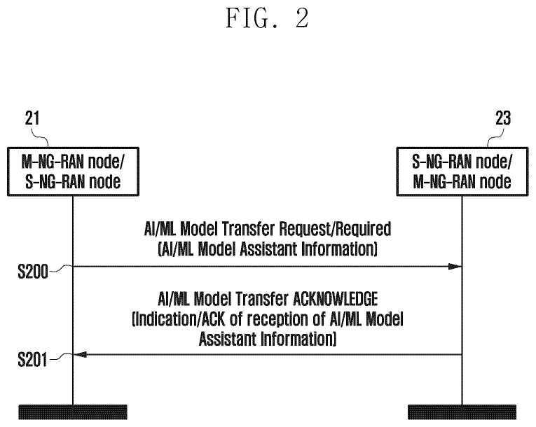

In certain examples, the network entity/function (e.g., MN) may send the AI/ML model(s) and any related assistance information. For example using:
SN Addition procedure (see FIG. 1, discussed below) or SN Modification procedure; or
a newly defined Class 2 or Class 1 procedure (see FIG. 2, discussed below).

FIG. 1 shows a representation of a method or call flow according to an example of the present disclosure. In particular, FIG. 1 shows an example of an update to the SN Addition procedure to include assistance information, for example “AI/ML Model Assistant Information”. That is, FIG. 1 shows an example on MN sending assistance information on AI/ML model(s) in SN Addition Request message (as part of SN Addition procedure), SN providing acknowledgement and/or indication of reception of the Assistant Information, and MN informing the UE of sending AI/ML model Assistant Information to the SN (e.g. transfer of AI/ML model and any related information, such as training data or other).

FIG. 1 shows a UE 11, a MN 13, a SN 15 and a UPF 17. However, it will be appreciated that this combination of network entities/functions is merely to provide an exemplary embodiment of the present disclosure and should not be considered as limiting. A person skilled in the art would appreciate that any of these entities/functions may be replaced by another (suitable) entity/function. As such, it may be helpful to consider numerals 11, 13, 15 and 17 to instead refer to first to fourth network entities/function.

FIG. 1 shows a number of steps or states. It will be appreciated that one or more of these steps or states may be modified (e.g., two or more steps or states may be combined), omitted (e.g., one or more of the steps or states may not be included in FIG. 1) or moved (e.g., the one or more steps, or a combination thereof, may be provided in a different order), in the procedure, if desired and appropriate, as would be understood by the skilled person. Additionally, it will be appreciated that additional steps or states may be added, or additional actions/operations performed in each described step or state.

In S100 (figure text: “0. AI/ML Model”): In an example, MN 13 is assumed to have the AI/ML model(s) to be transferred (with any relevant info) to SN 15 (to be added). In another example, MN 13 may not have the AI/ML model(s), but may optionally assist SN 15 in downloading or transferring the model from another network entity/function, or OAM.

In S101 (figure text: “1. SN Addition Request (AI/ML Model Assistance Information”): MN 13 may send SN Addition Request message including “AI/ML model Assistant Information” (e.g. AI/ML model(s) trained/untrained, and/or information related to model training, other). For example, MN 13 may transmit, to SN 15, a message to add SN 15, where SN 15 may perform model training as seen later.

In S102 (figure text: “2. AI/ML Model”): In an example, SN 15 may store the AI/ML model(s), received from (or transferred by, or downloaded from) MN 13. In another example, SN 15 may store the AI/ML model(s), received from (or transferred by, or downloaded from) the other NW entity/function or OAM.

In S103 (figure text: “3. SN Addition Request Acknowledge (Indication/ACK of reception of AI/ML Model Assistant Information”): SN 13 may acknowledge reception of the AI/ML model and/or any other assistance information (e.g., information related to training).

In S104 (figure text: “4. RRC reconfiguration Message (Indication of transfer of AI/ML model to SN”): MN 13 may inform UE 11 of transfer of the AI/ML model to the SN 15.

In S105 (figure text: “5. RRC reconfiguration complete message”), S106 (figure text: “6. SN Reconfiguration Complete”) and S107 (figure text: “7. Random Access Procedure”): UE 11 may establish a connection with SN 15.

In S108 (figure text: “8. Data Forwarding (Transfer training data via UP)”): UPF 17 may transfer the training data for the AI/ML model (at SN 15) using the UP. The training data may be forwarded to SN 15 for model training. It is assumed that UPF 17 (or another NW entity/function) has already, in a previous steps (not shown in FIG. 1), distinguished the training data from user data, for example in accordance with one or more of the methods described above.

In S109 (figure text: “9. UE measurement”): UE 11 may send measurements reports to SN 15.

In S110 (figure text: “10. Model Training”): SN 15 may perform model training.

In S111, S112, S113, S114 (figure text: “11. Model Deployment/update. 12. Model inference. 13. Action. 14. Feedback”): These steps may be performed at MN 13, SN 15 and/or UE 11. It will be appreciated that these steps may be omitted.

According to an example of the present disclosure, an AI/ML model may be transferred between network entities/functions (e.g., between RAN nodes) using a newly defined procedure (e.g., a newly defined Class 1 procedure). For example, an MN or SN can use a newly defined procedure (e.g. Xn signaling/messages) to transfer AI/ML model(s) (and/or any related information of AI/ML model(s)) between the MN and SN. The procedure can be UE associated or non-UE associated.

FIG. 2 shows a representation of a method or a call flow according to an example of the present disclosure. In particular, FIG. 2 shows an example of a newly defined Class 1 procedure to transfer/exchange AI/ML model(s) (trained, untrained, partially trained, or having other status) and/or other information related to the AI/ML model(s) between network entities (in the example of FIG. 2, these are MN (M-NG-RAN node) and SN (S-NG-RAN node), however the present disclosure is not limited thereto) and numerals 21 and 23 may instead refer to other network entities or network functions, as appropriate.

In S200, a M-NG-RAN node or S-NG-RAN node 21 performs AI/ML model transfer and/or AI/ML model assistant information transfer with a S-NG-RAN node or MNG-RAN node 23. For example, M-NG-RAN node 23 may send the AI/ML Model Transfer Request to S-NG-RAN node 21, or the S-NG-RAN node 21 may send the AI/ML Model Transfer Required message to the M-NG-RAN node 23, or vice versa.

In S201, the S-NG-RAN node 21 or M-NG-RAN node 23 sends AI/ML model transfer acknowledge (“ACKNOWLEDGE”) to the M-NG-RAN node 23 or SNG-RAN node 21 including an indication/ACK of reception of AI/ML model assistant information (e.g., if sent in S200). For example, MN 23 may transfer the AI/ML model and the training data to SN 21, or vice versa. In another example, the SN 21 may transfer the trained model back to the MN 23.

In an example, MN 23 may request to transfer model to SN 21, and SN 21 may acknowledge in response. In another example, SN 21 may require to transfer a model (e.g. trained model) to MN 23, and MN 23 may acknowledge in response. In another example not reflected in FIG. 2, for simplicity), SN 21 may send AI/ML model transfer required message to MN 23 (to trigger transfer of different model(s) or an updated model or a new model) from MN 23. Then MN 23 would send AI/ML model transfer request and SN 25 would ACK.

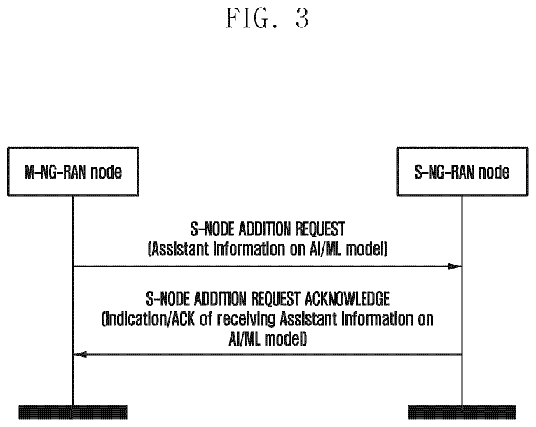

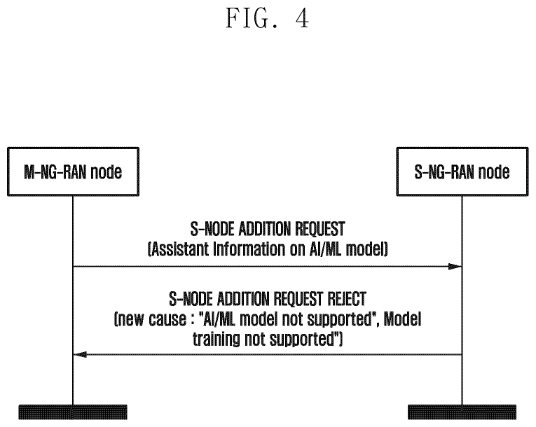

In a non-limiting example of the present disclosure, with reference to FIGS. 3 and 4, to illustrate certain examples of the present disclosure we now provide an example of an update to 3GPP TS 38.423 [6]:

S-NG-RAN node Addition Preparation

The M-NG-RAN node initiates the procedure by sending the S-NODE ADDITION REQUEST message to the S-NG-RAN node including assistant information on AI/ML model to be transferred to S-NG-RAN node to be trained at the S-NG-RAN node.

The S-NG-RAN node shall, if supported, send an indication or acknowledgement to the M-NG-RAN node, in the S-NODE ADDITION REQUEST ACKNOWLEDGE message, that it has received the Assistant Information on AI/ML model.
[Note: Refer here to FIG. 3, showing S-NG-RAN node Addition Preparation, successful operation; e.g., FIG. 3 may be inserted at this point]

If the S-NG-RAN node is not able to accept the transfer of AI/ML model and/or training the AI/ML model, or a failure occurs during the S-NG-RAN node Addition Preparation, the S-NG-RAN node sends the S-NODE ADDITION REQUEST REJECT message with an appropriate cause value to the M-NG-RAN node. For example, a new cause value “AI/ML model not supported”, “Model training not supported”, or any other suitable cause value.
[Note: Refer here to FIG. 4, showing S-NG-RAN Addition Preparation, unsuccessful operation; e.g., FIG. 4 may be inserted at this point]

### M-NG-RANnode Initiated S-NG-RANnode Modification Preparation

The M-NG-RAN node initiates the procedure by sending the S-NODE MODIFICATION REQUEST message to the S-NG-RAN node including assistant Information on AI/ML model trained at S-NG-RAN node. For example, the information may optionally include updates of AI/ML model(s), previously transferred to S-NG-RAN, and/or any new AI/ML model(s) to be transferred to S-NG-RAN.

The S-NG-RAN node shall, if supported:
store and replace the previously provided assistant information on AI/ML model(s), if any, by the newly received assistant information in S-NODE MODIFICATION REQUEST message;

The S-NG-RAN node shall, if supported, send an indication or acknowledgement to the M-NG-RAN node, in the S-NODE MODIFICATION REQUEST ACKNOWLEDGE message, that it has received the Assistant Information on AI/ML model.

If the S-NG-RAN node is not able to accept the update or modification of the AI/ML model and/or training the AI/ML model, the S-NG-RAN node sends the S-NODE MODIFICATION REQUEST REJECT message to the M-NG-RAN node including an appropriate cause. For example, a new cause IE value “Model update not supported”, “Model training update not supported”, or any other suitable cause value.
[Note: Text of FIG. 3: top operation—“S-NODE ADDITION REQUEST (Assistant Information on AI/ML model)”; bottom operation—“S-NODE ADDITION REQUEST ACKNOWLEDGE (Indication/ACK of receiving Assistant Information on AI/ML model)” ]
[Note: Text of FIG. 4: top operation—“S-NODE ADDITION REQUEST (Assistant Information on AI/ML model)”; bottom operation—“S-NODE ADDITION REQUEST REJECT (new cause: “AI/ML model not supported”, Model training not supported”)” ]

According to certain examples of the present disclosure, notification and/or behaviour of network entities/functions (e.g., network nodes such as MN/SN) may differ based on model training status.

In an example, an SN (S-NG-RAN node) may explicitly notify/report to an MN (or UE, and/or another network entity/function) the model training status (complete, failed, updated, other etc.). Optionally, the SN may also send the trained AI/ML model to the MN (M-NG-RAN node).

In another example, an SN (S-NG-RAN node) may implicitly notify/report to an MN (or UE, and/or another network entity/function) the completion of model training by sending the trained model to MN (M-NG-RAN node).

In another example, an SN (S-NG-RAN node) may notify/report to an MN (or UE, and/or another network entity/function) the (successful) completion of model training, send the trained model to MN (M-NG-RAN node), and (optionally) trigger SN initiated SN Release.

In another example, an MN (M-NG-RAN node), after receiving the model training status (e.g. successfully completed) and/or trained model, may trigger MN initiated SN Release.

In another example, an MN, after receiving a trained AI/ML model, may perform model inference based on input data for inference.

In another example, an SN, after completion of model training, may perform the model inference based on input data for inference.

In another example, an SN and MN may jointly perform model training and/or model inference.

In another example, an MN (M-NG-RAN node) may explicitly notify/report to an SN (or UE, and/or another network entity/function) the model training status (complete, failed, updated, other). Optionally, the MN may also send the trained AI/ML model to the SN (S-NG-RAN node).

In another example, an MN, after receiving the trained AI/ML model, may trigger the MN initiated SN Modification procedure to provide any AI/ML model updates (or any other modified AI/ML model parameters) to an SN.

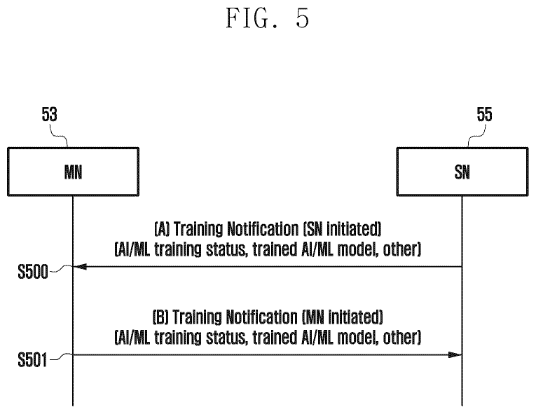

In certain examples, the SN/MN may exchange notification of model training status and/or (optionally) trained model (and/or any assistant information related to the trained/updated model) using, for example:
existing EN-DC (or MR-DC) related procedure, e.g. SN Modification (MN/SN initiated) procedure; or
a newly defined Class 2 (see FIG. 5) or Class 1 procedure.

In another example, an MN, after receiving the trained AI/ML model, may trigger the MN initiated SN release.

In another example, an MN, after receiving the trained AI/ML model, may trigger the MN initiated SN Modification procedure to provide any AI/ML model updates (or any other modified AI/ML model parameters) to the SN.

It will be appreciated that the present disclosure includes each of the above examples relating to notification and/or behaviour of network entities/functions both alone and in any combination with other example(s). Furthermore, although some of examples above may refer to an MN and/or an SN, it will be appreciated that the reference to MN and SN is non-limiting, and that other network entities/functions may be used instead in these examples.

Referring to FIG. 5 as mentioned above, FIG. 5 shows a representation of a call flow according to an example of the present disclosure. In particular, FIG. 5 shows an example of a new Class 2 procedure to notify MN/SN of training status at SN(A)/MN(B).

In FIG. 5, there is shown an MN 53 and an SN 55. It will be appreciated that only one of S500 and S501 may be performed; e.g., depending on whether SN 55 or MN 53 initiates.
S500 figure text: “(A) Training Notification (SN initiated) (AI/ML training status, trained AI/ML model, other)”.
S501 figure text: “(B). Training Notification (MN initiated) (AI/ML training status, trained AI/ML model, other.

For example, the purpose of S500 (Training Notification (SN initiated)) is for the SN 55 to indicate to MN 53 the completion of training (successfully), and optionally send the trained model to the MN 53 for inference, or may optionally perform inference and send to the MN 53 the indication of training completion together with the inference, or may only send the trained model or only send the inference, or any combination of the previous.

The purpose of S501 (Training Notification (MN initiated)) is similar to that for S500. Moreover, after sending the training completion notification, trained mode, and/or inference, SN 55 or MN 53 may trigger/initiate the release of the SN 55 (e.g. SN Release procedure—MN initiated/SN initiated, or a newly defined SN release procedure), Secondary Node Change (MN/SN initiated), Conditional SN change procedure (MN/SN initiated) or any suitable existing or newly defined EN-DC or MR-DC procedure. It would be appreciated that for simplicity those procedures are not shown FIG. 5, however, still these procedures are within the scope of certain examples of the present disclosure.

In general, it will be appreciated that FIG. 5 shows a non-limiting example and does not show (for simplicity of demonstration) other network entities/functions and/or UE that may also be included in the communications network.

The examples above handle one or more of classification, differentiation, splitting of training data for AI/ML in a network (or core network or 5G CN (core network)). However, regardless of core network (e.g. 5G CN), a gNB itself can perform or undertake classification/differentiation/splitting of training data for AI/ML. An example of this is gNB operating edge computing function for AI/ML methods. In such a case, for example, training and AI/ML application may be performed between the gNB and UE. Hence, in an example, the training data can be labelled by the gNB. The labelling can be indicated in one of L2 headers (SDAP or PDCP or MAC headers) and can be also indicated by RRC message (e.g. QFI or LCID (Logical Channel Identifier)).

If the network classifies or differentiates or splits AI/ML related data, then the RAN (or gNB) may further differentiate them (the classified or differentiated or split AI/ML related data) and may process them in a variety of ways as follows:

In an example, QFI (QoS Flow ID) can be pre-defined for AI/ML training data traffic to let UE (or gNB) know (or detect, or determine), or be capable of knowing, whether SDAP SDU (Service Data Unit) is AI/ML training data or not, where QFI is used in SDAP (Service Data Adaptation Protocol) header generated (or processed) in SDAP layer.

In another example, a RRC (Radio Resource Control) message that a gNB transmits to a UE for configuration may indicate QFIs as AI/ML training data—this may not require pre-defined QFI described in the prior example above.

In another example, SDAP control PDU may be defined to indicate QFI to be used for AI/ML related data.

In certain examples of the present disclosure, if training data for AI/ML is differentiated from user data, the network can allocate a/the separate carrier or channel for the UE(s) because the training data itself is not urgent data. It would be reasonable to have separate carrier (or channel) to handle this, i.e., one or more training dedicated carriers or channels. The carrier can be a BWP (Bandwidth Part) a SUL (supplement Uplink) or a SCell, which only transmit and receive AI/ML related data (e.g. training data or control data). The network (or gNB) may configure the separate carrier (or channel) for AI/ML related data transmission and reception.

In another example, the training dedicated channel may be logical channel, i.e., AI/ML related data can be allocated with a LCID, which enables the gNB (or UE) to process them with different criteria (e.g. priority, PBR (prioritised Bit Rate), subcarrier spacing, etc.) differently from user data and which can be configured by RRC message generated by the network (or gNB). The MAC (Medium Access Control) entity may multiplex the training data and user data into a MAC PDU, but the training data may be processed in separate RLC (Radio link control) entity and PDCP (Packet data convergence protocol) entity different from those of user data.

In another example, when the training dedicated channel can be logical channel as described above, the MAC entity may limit multiplexing only to the training data while multiplexing user data separately, which may enable the network to prioritize radio resources (frequency or time resources) per MAC PDU. It also enables the application of separate HARQ (Hybrid automatic repeat request) process to AI/ML training data by the network/MAC entity.

In certain examples, for AI/ML training data, an RLC entity can be configured with RLC AM (Acknowledged Mode) mode or TM (Transparent Mode) mode or UM (Unacknowledged Mode) mode or UM for uni-directional or UM for bi-directional. Given that the training data is not very/substantially/particularly sensitive to AI/ML update, the configuration of RLC may be limited to RLC UM mode, which does not incur unnecessary ARQ mechanism in RLC entities.

In another example, the configuration of RLC can be limited to RLC TM mode, which does not incur unnecessary ARQ mechanism and can reduce the header overhead in RLC entities.

According to certain examples of the present disclosure, the above proposals can be extended to integrated access and backhaul (IAB) nodes by allocating different backhaul RLC channel (e.g. RLC channel Identifier) for AI/ML related data on a specific hop, and/or a different path overall to the destination for AI/ML data than user data. For example, an IAB donor may configure the RLC Channel IDs and/or path IDs to IAB node(s) by RRC message or F1AP (F1 application protocol) message. The IAB donor may also configure multiple paths for user data and only a single path for AI/ML training data (offering less redundancy and support in case RLF occurs). And, in a further example specific to the upstream, the network may configure, or only configure, BSR (buffer status report) and/or pre-emptive BSR for logical channel groups containing user data. This different treatment of AI/ML data can apply to scheduling assistance data other than BSR. Specific to the downstream, the network may only configure flow control feedback for backhaul channels carrying user data.

According to certain examples of the present disclosure, the PDCP layer may differentiate the training data from user data by inspecting PDCP header or upper layer headers and may apply different security protection to the PDCP SDU corresponding to training data. For example, the PDCP entity may not perform ciphering or integrity protection function to the training data because some training data have no personal or infrastructure-sensitive information based on the type of AI/ML model—this may reduce processing load (e.g. in this example the type of AI/ML model may be a federated learning model). In another example, the PDCP entity may only perform ciphering or only perform integrity protection to the training data to reduce the processing burden. In another example, the PDCP layer may indicate whether to perform ciphering for PDCP SDU (Service Data Unit), e.g., training data or integrity protection for PDCP PDU (Protocol Data Unit), e.g., training data with indication in PDCP header. This makes the receiving PDCP entity get to know if ciphering or integrity protection was applied to the receive PDCP PDU (or PDCP SDU or training data).

In another example, the PDCP layer may only process AI/ML related data (or training data or control data) when dedicated RLC channel or DRB is used for AI/ML related data and configured by RRC message. The PDCP layer may perform security protection to PDCP SDUs unlike the PDCP entity corresponding to DRB handling user data. For example, the PDCP entity does not perform ciphering or integrity protection function to the training data because some training data have no personal information based on the type of AI/ML model and it can reduce processing load (e.g., the AI/ML model may be of a federated learning model type in this case). The RRC message can configure for this DRB (or this PDCP entity) whether to perform ciphering or integrity protection function

In certain examples, the RRC message referred to above can be RRCReconfiguration or RRCResume or RRCSetup or RRCRelease messages or a newly-defined message.

According to certain examples, by differentiating AI/ML training data in RAN side, a UE (or a gNB) may apply different data processing to the AI/ML training data separately in MAC or RLC or PDCP or SDAP layers.

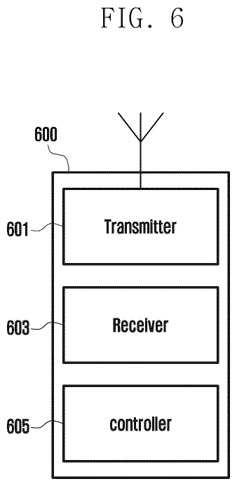

FIG. 6 is a block diagram illustrating an exemplary network entity 600 (or electronic device 600, or network node 600 etc.) that may be used in examples of the present disclosure.

For example, any of the network entities, functions, nodes etc. (e.g., UE, MN, SN, UPF, NG-RAN node, gNB, CN etc.) mentioned above may be implemented by or comprise network entity 600 (or be in combination with a network entity 600) such as illustrated in FIG. 6. The network entity 600 may comprise a controller 605 (or at least one processor) and at least one of a transmitter 601, a receiver 603, or a transceiver (not shown).

For example, referring to FIG. 1 for illustrative purposes, in a case where UE 11 is implemented using network entity 600: receiver 603 may be configured to be used in the process(es) of one of more of: receiving an indication of transfer of the AI/ML model to the SN 15 from the MN 13, establishing a connection with SN 15, and, optionally, model deployment/update, model inference, action and/or feedback; transmitter 601 may be configured to be used in the process(es) of one or more of: establishing the connection with SN 15, sending measurement reports to SN 15, and, optionally, model deployment/update, model inference, action and/or feedback; and controller 605 may be configured to be used in the process(es) of one or more of: performing one of the aforementioned operations and/or controlling the receiver 603 and/or the transmitter 601 in performing one of the aforementioned operations.

In a case where MN 13 is implemented using network entity 600: the transmitter 601 may be configured to be used in the process(es) of one or more of: sending an SN addition request message to SN 15 (which may include assistance information (i.e., information related to training)), informing UE 11 of the transfer of the AI/ML model to SN 15, establishing a connection between UE 11 and SN 15, forwarding training data to SN 15, using the UP, and, optionally, model deployment/update, model inference, action and/or feedback; the receiver 603 may be configured to be used in the process(es) of one or more of: receiving SN acknowledge of reception of the AI/ML model and/or any assistance information from SN 15, establishing a connection between UE 11 and SN 15, and, optionally, model deployment/update, model inference, action and/or feedback; and controller 605 may be configured to be used in the process(es) of one or more of: performing one of the aforementioned operations and/or controlling the receiver 603 and/or the transmitter 601 in performing one of the aforementioned operations.

In a case where the SN 15 is implemented using network entity 600: the receiver 603 may be configured to be used in the process(es) of one or more of: receiving an SN addition request message from MN 13 (which may include assistance information (i.e., information related to training)), establishing a connection between UE 11 and SN 15, receiving training data for the AI/ML model via the UP, and, optionally, model deployment/update, model inference, action and/or feedback; the transmitter 601 may be configured to be used in the process(es) of on or more of: transmitting SN acknowledge of reception of the AI/ML model and/or any assistance information to MN 13, and, optionally, model deployment/update, model inference, action and/or feedback; and controller 605 may be configured to be used in the process(es) of one or more of: performing one of the aforementioned operations and/or controlling the receiver 603 and/or the transmitter 601 in performing one of the aforementioned operations.

In a case where UPF 17 is implemented using network entity 600: at least one of the transmitter 601, the receive 603 and the controller 605 may be configured to be used in the process of forwarding the AI/ML model training data to SN 15.

There now follow a number of examples according to the present disclosure. Although recited separately, it will be appreciated that the present disclosure also includes each and every combination of the following examples, without limitation.

According to an example of the present disclosure: a first network entity or network function included in a communications network, wherein the first network entity or network function is configured to: determine whether traffic or a data packet is associated with training data for a AI/ML model.

According to another example, the traffic or data packet is associated with training data for the AI/ML model if the traffic or data packet is labelled as and/or inferred as training data for the AI/ML model.

According to another example, the first network entity or network function is configured to: based on determining that the traffic or data packet is associated with training data, process the traffic or data packet according to one or more parameters. For example, the one or more parameters include one or more of: a modulation and coding scheme, a security level, a protection level, a transmission parameter, a delay parameter, an energy parameter, a network configuration or a reliability parameter.

According to another example, the first network entity or network function is configured to: based on determining that the traffic or data packet is not associated with training data, differently process the traffic or data packet according to the one or more parameters. For example, a modulation and coding scheme used by the first network entity or network function for the traffic or data packet associated with training data is different from a modulation and coding scheme used by the first network entity or network function for traffic or a data packet which is not associated with training data.

According to another example, the first network entity or network function is configured to transmit the processed traffic or data packet to a second network entity or network function, included in the communications network.

According to another example, the first network entity or network function is configured to: determine whether the traffic or data packet is associated with training data for a AI/ML model based on information received from a third network entity or network function included in the communication network, or based on at least one characteristic of the traffic or data packet. For example, the information may be assistance information related to training data packets/streams to assist in training data classification at the first network entity or network function. For example, the characteristic may include one or more of: frequency of the training data, size of the training data, pattern of the training data, burst length of the traffic or data packet, periodicity of the traffic or data packet, on-off periods of the traffic or data packets, and a QoS flow or PDU session used for the traffic or data packet.

According to another example, the first network entity or network function is a UPF or NG-RAN, wherein the second network entity is a SN or UE, and wherein the third network entity is an AF, AMF or SMF, and wherein the wireless communications network is a 5G NR network or a 6G network.

According to another example of the present disclosure, a first network entity or network function included in a communications network, wherein the first network entity or network function is configured to: classify traffic or a data packet as being associated with training data for a AI/ML model.

According to another example, the first network entity or network function is configured to classify the traffic or data packet as being associated with training data based on a predetermined 5QI value. According to another example, the first network entity or network function is configured to classify the traffic or data packet as being associated with training data based on a predetermined 5QI value and label the data accordingly.

According to another example, the first network entity or network function is configured to transmit, to a second network entity or network function, an indication that the traffic or data packet is associated with training data based on the predetermined 5QI value.

According to another example of the present disclosure, a second network entity or network function included in a communications network is configured to receive, from a first network entity or network function included in the communications network, an indication that traffic or a data packet, received at the second network entity or network function, is associated with training data.

According to another example of the present disclosure, a network entity or network function included in a communications network is configured to, based on determining that a part of traffic or data packets are associated with training data, split the traffic or data packets into first traffic or data packets associated with training data and second traffic or data packets associated with non-training data. For example, the non-training data may be user data. In some examples, the user data includes one or more of user-generated data, application generated data, non-overhead data, data originating from outside the network and/or application (such as user-generated, or generated by another application) etc.

According to another example, the network entity or network function may split a PDU session to enable separation of the first traffic or data packets and the second traffic or data packets. For example, the network entity or network function may split the PDU session during PDU session resource setup or during PDU session resource modify.

According to another example, the network entity or network function is an MN and is configured to add a SN, and forward the first traffic or data packets to the SN for the SN to perform model training.

According to another example of the present disclosure, a network entity or network function included in a communications network is configured to, upon determining that traffic or a data packet is associated with training data, process the traffic or data packet based on the traffic or data packet being associated with training data.

According to another example, the processing may be different to a case where the traffic or data packet is not associated with training data.

According to another example, the processing may include one or more of: providing modulation and coding schemes, security and protection level, or lower delay, energy and/or reliability requirements.

According to another example, the processing may include one or more of: transmitting the traffic or data packet associated with training data to another network entity or network function using best-effort, non-GBR, or low QoS values DRBs; using different bandwidth parts, different carriers or different carrier groups for the traffic or data packets associated with the training data; using different LCP values configured for the traffic or data packets associated with the training data (e.g., compared to LCP values used for traffic or data packets not associated with the training data), using different L1/L2 transmission parameters configured for the traffic or data packets associated with the training data (e.g., compared to L1/L2 transmission parameters used for traffic or data packets not associated with the training data); and combining the traffic or data packets associated with the training data with traffic or data packets not associated with the training data in the same DRBs or separate DRBs.

In accordance with another example of the present disclosure, a first network entity or network function included in a communication network is configured to transmit, to another network entity or network function included in the communication network, assistance information for transferring an AI/ML model and/or training data to the other network entity or network function.

In accordance with another example, the assistance information comprises one or more of: an ID of the AI/ML model, information on deployment of the AI/ML model, information on training of the AI/ML model, information on training status of the AI/ML model (e.g., completed, untrained, or partially-trained), information on transfer of the AI/ML model (e.g., full, or partial), information on update of the AI/ML mode, information on a use case of the AI/ML model (e.g., load balancing, energy saving, mobility optimisation, CSI feedback enhancement, beam management, and/or positioning accuracy enhancements), information on a network-UE collaboration level for the AI/ML model, a training type (e.g., online, or offline), information on a training session ID, information on a training update, information on training validity, and information on the AI/ML model inference.

In accordance with another example, the first network entity or network function is configured to transmit the assistance information using SN addition procedure or SN modification procedure, or a newly defined Class 1 or Class 2 procedure.

It will be appreciated that the present disclosure also includes methods as performed by the entities and functions etc. described above. To give but one example, the present disclosure includes a method by a network entity or network function included in a communications network, wherein the method comprises classifying traffic or data packets as being associated with training data for an AI/ML model.

Similarly, the present disclosure should also be seen to disclose computer-readable storage media comprising instructions which, when executed by a processor (for example, a processor corresponding to controller 605 of a network entity/function), cause the processor to perform any method in accordance with the above.

All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

For example, a person skilled in the art would appreciate that examples described above may be combined to provide one example whereby: a first network entity/function classifies or labels traffic (or data packets) as training data (or being associated with training data), for example using a 5QI value; a second network entity/function, upon reception of the traffic and an indication of the classification of the traffic, determines that the traffic is training data based on the indication, and processes the traffic based on determining it as being the training data (e.g., configured one or more transmission parameters of the training data based on the determination, such as by using an indicated 5QI value to determine corresponding QoS characteristics); and a third network entity/function, upon receiving the processes traffic, uses the training data for model training based on the processes traffic being the training data. It will be appreciated that such an example, representing a combination of various examples disclosed above, is clearly part of the present disclosure (amongst other examples relating to each and every combination of the examples disclosed above).

The techniques described herein may be implemented using any suitably configured apparatus and/or system. Such an apparatus and/or system may be configured to perform a method according to any aspect, embodiment, or example disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

It will be appreciated that examples of the present disclosure may be implemented in the form of hardware, software or any combination of hardware and software. Any such software may be stored in the form of volatile or non-volatile storage, for example a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement certain examples of the present disclosure. Accordingly, certain examples provide a program comprising code for implementing a method, apparatus or system according to any example, embodiment, and/or aspect disclosed herein, and/or a machine-readable storage storing such a program. Still further, such programs may be conveyed electronically via any medium, for example a communication signal carried over a wired or wireless connection.

While the invention has been shown and described with reference to certain examples, it will be understood by those skilled in the art that various changes in form and detail may be made therein without departing from the scope of the invention.

The reader's attention is directed to all papers and documents which are filed concurrently with or previous to this specification in connection with this application and which are open to public inspection with this specification, and the contents of all such papers and documents are incorporated herein by reference.

### ACRONYMS AND DEFINITIONS

3GPP 3^{rd} Generation Partnership Project
5G 5^{th} Generation
5GC 5G Core
5QI 5G QoS Identifier
5GS 5G System
5GSM 5G System Session Management
5GMM 5G System Mobility Management
AF Application Function
AI Artificial Intelligence
AM Acknowledged Mode
AMF Access and Mobility Management Function
AS Application Server
ASP Application Service Provider
AUSF Authentication Server Function
DCAF Data Collection Application Function
DNAI Data Network Access Identifier
DNN Data Network Name
DNS Domain Name Server
DRB Data Radio Bearer
eNB Evolved Node B
FQDN Fully Qualified Domain Name
GBR Guaranteed Bit Rate
gNB Next generation Node B
GPSI Generic Public Subscription Identifier
IAB Integrated Access and Backhaul
ID Identity/Identifier
IMEI International Mobile Equipment Identities
IP Internet Protocol
I-SMF Intermediate SMF
ML Machine Learning
MME Mobility Management Entity
MN Master Node
MNO Mobile Network Operator
MT Mobile Termination
NAS Non-Access Stratum
NEF Network Exposure Function
NRF Network Repository Function
NG-RAN Next Generation Radio Access Network
NG-eNB Next Generation eNB
NSA Non-Standalone
NSSF Network Slice Selection Function
NW Network
NWDAF Network Data Analytics Function
OS Operating System
OSAPP OS Application
PCF Policy Control Function
PCO Protocol Configuration Options
PDR Packet Detection Rule
PDU Protocol Data Unit
QFI QoS Flow Identifier (ID)
QoS Quality of Service
RAN Radio Access Network
RSD Route Selection Descriptor
SA Standalone
SDAP Service Data Adaptation Protocol
SDU Service Data Unit
SIM Subscriber Identity Module
SLA Service Level Agreement
SM Session Management
SMF Session Management Function
SN Secondary Node
S-NSSAI Single Network Slice Selection Assistance Information
SSC Session and Service Continuity
SUPI Subscription Permanent Identifier
TAI Tracking Area Identity
TE Terminal Equipment
TM Transparent Mode
TS Technical Specification
UDM Unified Data Manager
UDR Unified Data Repository
UE User Equipment
UL Uplink
UM Unacknowledged Mode
UP User Plane
UPF User Plane Function
URSP UE Route Selection Policy

1-15. (canceled)

16. A first entity in a communication system, the first entity comprising:
a transceiver; and
at least one processor coupled with the transceiver and configured to:
while a first connection with a user equipment (UE) is established, transmit, to a second entity, information relating to an artificial intelligence/machine learning (AI/ML) model, wherein the information is usable for obtaining at least one of the AI/ML model or data relating to the AI/ML model,
transmit, to the UE, a first message to trigger the UE to establish a second connection with the second entity, wherein the first message indicates that the second entity has obtained at least one of the AI/ML model or the data relating to the AI/ML model, and
transmit, to the second entity, AI/ML data for the AI/ML model.

17. The first entity of claim 16, wherein the information relating to the AI/ML model comprises at least one of information on the AI/ML model, information on an update to the AI/ML model, information on the data relating to the AI/ML model, or assistance information on the AI/ML model.

18. The first entity of claim 17, wherein the assistance information comprises at least one of information on an identifier (ID), information on a deployment, information on an AI/ML training, information on a transfer, information on an AI/ML model update, information on a use case, information on a level, or information on an AI/ML model inference.

19. The first entity of claim 16, wherein the at least one processor is further configured to:
receive, from a user plane function (UPF), data, and
identify at least part of the data as the AI/ML data based on at least one of information on a label, information on a quality of service (QoS), information on 5G QoS indicator (5QI), information on an identifier (ID), information on a volume, information on a structure, or information on a data format,
wherein a transmission of the AI/ML data is performed differently from a transmission of the other data.

20. A second entity in a communication system, the second entity comprising:
a transceiver; and
at least one processor coupled with the transceiver and configured to:
receive, from a first entity having a first connection with a user equipment (UE), information relating to an artificial intelligence/machine learning (AI/ML) model, wherein the information is usable for obtaining at least one of the AI/ML model or data relating to the AI/ML model,
obtain at least one of the AI/ML model or the data relating to the AI/ML model, based on the information,
establish a second connection with the UE,
receive, from the first entity, AI/ML data for the AI/ML model, and
perform, based on the at least one of the AI/ML model or the data relating to the AI/ML model, training of the AI/ML model to provide an updated AI/ML model based on the second connection.

21. The second entity of claim 20, wherein the information relating to the AI/ML model comprises at least one of information on the AI/ML model, information on an update to the AI/ML model, information on the data relating to the AI/ML model, or assistance information on the AI/ML model.

22. The second entity of claim 21, wherein the assistance information comprises at least one of information on an identifier (ID), information on a deployment, information on an AI/ML training, information on a transfer, information on an AI/ML model update, information on a use case, information on a level, or information on an AI/ML model inference.

23. The second entity of claim 20,
wherein data is transmitted to the first entity from a user plane function (UPF),
wherein at least part of the data is identified as the AI/ML data based on at least one of information on a label, information on a quality of service (QoS), information on 5G QoS indicator (5QI), information on an identifier (ID), information on a volume, information on a structure, or information on a data format, and
wherein a transmission of the AI/ML data is performed differently from a transmission of the other data.

24. A method performed by a first entity in a communication system, the method comprising:
while a first connection with a user equipment (UE) is established, transmitting, to a second entity, information relating to an artificial intelligence/machine learning (AI/ML) model, wherein the information is usable for obtaining at least one of the AI/ML model or data relating to the AI/ML model;
transmitting, to the UE, a first message to trigger the UE to establish a second connection with the second entity, wherein the first message indicates that the second entity has obtained at least one of the AI/ML model or the data relating to the AI/ML model; and
transmit, to the second entity, AI/ML data for the AI/ML model.

25. The method of claim 24, wherein the information relating to the AI/ML model comprises at least one of information on the AI/ML model, information on an update to the AI/ML model, information on the data relating to the AI/ML model, or assistance information on the AI/ML model.

26. The method of claim 25, wherein the assistance information comprises at least one of information on an identifier (ID), information on a deployment, information on an AI/ML training, information on a transfer, information on an AI/ML model update, information on a use case, information on a level, or information on an AI/ML model inference.

27. The method of claim 24, further comprising:
receiving, from a user plane function (UPF), data; and
identifying at least part of the data as the AI/ML data based on at least one of information on a label, information on a quality of service (QoS), information on 5G QoS indicator (5QI), information on an identifier (ID), information on a volume, information on a structure, or information on a data format,
wherein a transmission of the AI/ML data is performed differently from a transmission of the other data.

28. A method performed by a second entity in a communication system, the method comprising:
receiving, from a first entity having a first connection with a user equipment (UE), information relating to an artificial intelligence/machine learning (AI/ML) model, wherein the information is usable for obtaining at least one of the AI/ML model or data relating to the AI/ML model;
obtaining at least one of the AI/ML model or the data relating to the AI/ML model, based on the information;
establishing a second connection with the UE;
receiving, from the first entity, AI/ML data for the AI/ML model; and
performing, based on the at least one of the AI/ML model or the data relating to the AI/ML model, training of the AI/ML model to provide an updated AI/ML model based on the second connection.

29. The method of claim 28,
wherein the information relating to the AI/ML model comprises at least one of information on the AI/ML model, information on an update to the AI/ML model, information on the data relating to the AI/ML model, or assistance information on the AI/ML model, and
wherein the assistance information comprises at least one of information on an identifier (ID), information on a deployment, information on an AI/ML training, information on a transfer, information on an AI/ML model update, information on a use case, information on a level, or information on an AI/ML model inference.

30. The method of claim 28,
wherein data is transmitted to the first entity from a user plane function (UPF),
wherein at least part of the data is identified as the AI/ML data based on at least one of information on a label, information on a quality of service (QoS), information on 5G QoS indicator (5QI), information on an identifier (ID), information on a volume, information on a structure, or information on a data format, and
wherein a transmission of the AI/ML data is performed differently from a transmission of the other data.
